(19) United States
(12) Patent Application Publication
(10) Pub. No.: US 2026/0170823 A1
(43) Pub. Date: Jun. 18, 2026

(54) Method of Generating a Scene Graph from an Input Image

(71) Applicant: Robert Bosch GmbH, Stuttgart (DE)

(72) Inventors: Daria Stepanova, Leonberg (DE); Jan Hendrik Metzen, Boeblingen (DE); Trung Kien Tran, Stuttgart (DE); Youmna Salah Mahmoud Ismaeil, Stuttgart (DE)

(21) Appl. No.: 19/418,709

(22) Filed: Dec. 12, 2025

(30) Foreign Application Priority Data
Dec. 16, 2024 (EP) 24220355.2

(51) Int. Cl. G06V 10/86; B25J 9/16; G06F 40/40

(52) U.S. Cl. CPC G06V 10/86; B25J 9/1697; G06F 40/40

(57) ABSTRACT

A computer-implemented method of generating a scene graph from an image using iterative refinement of an initial textual description is disclosed. A machine learning system generates the initial description based on the image and an initial question. Triplets (source node, relation, target node) are extracted. Iteratively, attributes of existing nodes, determined from a data base, seed new questions to the machine learning system, producing further descriptions and triplets. The final scene graph is constructed from all extracted triplets.

This application claims priority under 35 U.S.C. § 119 to patent application no. EP 24220355.2, filed on Dec. 16, 2024 in the European Patent Office, the disclosure of which is incorporated herein by reference in its entirety.

The disclosure relates to a computer implemented method of generating a scene graph from an input image, a corresponding system, a computer program, and a machine-readable storage medium.

### BACKGROUND

Scene graph generation from visual content has proven effective in semantic image retrieval and captioning. Existing approaches utilize scene graphs derived from human-annotated image captions, https://arxiv.org/abs/1602.07332, or leverage foundation models, https://arxiv.org/abs/2310.01356. Some applications may require user input for object identification or bounding box annotations, e.g. https://arxiv.org/abs/2107.14178, https://arxiv.org/abs/2103.15365.

### SUMMARY

According to a first aspect, the disclosure relates to a computer-implemented method of generating a scene graph from an input image. The input image may be a digital image. Preferably, the input image may be acquired with a sensor of a video camera or a camera. The method comprises the following steps. In a first method step, an initial textual description of the image is generated from the input image and an initial natural language question. To this end, the input image and the initial natural language question are provided as input data to a machine learning system and the machine learning system generates, as output data, the initial textual description of the image. The initial natural language question may request the description of the semantic content of parts of/the full input image. Generally, the machine learning system may be a multimodal foundation model receiving digital images and text as input and determining a textual description of the image as output, while taking the request in the input text into account in the output textual description. As a non-limiting example, the machine learning system may be given by the Large Language and Vision Assistant (LLaVA) model, an end-to-end trained large multimodal model that connects a vision encoder and an Large Language Model (LLM) for general-purpose visual and language understanding, https://arxiv.org/pdf/2304.08485. In a subsequent method step, an initial set of triplets is extracted by an information extraction module, wherein the information extraction module receives the initial textual description as an input. In other words, an initial set of triplets is extracted from the initial textual description by the information extraction module. Each triplet comprises a source node, a relation, and a target node. For instance, the information extraction module may extract information using an OpenIE component, such as, e.g., the Stanza OpenIE component described in https://arxiv.org/abs/2003.07082. Generally, the information extraction module may extract structured information in the form of triples-source, relation, target—from an (unstructured) text, without relying on domain specific knowledge or pre-defined relations. Next, for a number of N iterations with N>1, N a natural number, the following method steps are performed: at least one source or target node from a current set of triplets is selected. Thereby, the initial set of triplets forms the current set of triplets for a first iteration. Then, an attribute related to the at least one selected source or target node is determined from a data base. The data base shall comprise entities and their corresponding attributes, wherein the attributes are assigned to specific entities. An entity may be, e.g., an object. For instance, the data base may be a graph structured data base. In a subsequent step, a question is determined based on the selected source or target node and the corresponding determined attribute. Subsequently, a further textual description of the image is determined from the image and the determined question by the machine learning system. Accordingly, the further textual description is responsive to the determined question. In other words, the further textual description addresses and/or answers the question that was determined and provided to the machine learning system. That is, phrased in yet another way, the textual description provides information relevant to the question. In a subsequent step, a further set of triplets is extracted from the further textual description by the information extraction module. Next, the current set of triplets and the further set of triplets are combined to an updated set of triplets. The updated set of triplets then forms the current set of triplets for a next iteration. Once the maximal number N of iteration is reached, the scene graph is constructed from the combined sets of triplets after N iterations.

A scene graph, in context of this disclosure, is a structured data representation of semantic relationships within an image and/or the scene depicted in the image-optionally including relationships related to image quality and/or mode-comprising nodes representing objects and/or attributes, and edges representing the semantic relationships between respective nodes.

Advantageously, the method, in particular its iterative approach, allows to progressively build a more comprehensive and accurate understanding of the input image's content by leveraging targeted questions guided by both extracted information (extracted from the image itself) and external knowledge. This results in a more detailed and robust scene graph compared to methods relying solely on a single initial image description. This, in particular, enables deeper insights into the image content. Furthermore, the method allows creating scene graphs in an unsupervised and dynamic approach using, e.g., open-source foundation models and open-source data bases, enabling deeper insights into image content.

Preferably, the scene graph comprises nodes representing the sources and targets of the combined sets of triplets and comprises edges between nodes representing the relations connecting the sources and targets.

Advantageously, the generated scene graph uses a standard graph representation, with nodes representing the entities (sources and targets) and edges representing the relationships (predicates/relations) between them. This may enhance the scene graph's usability and compatibility with standard graph processing techniques and tools.

Preferably, the initial natural language question comprises an request for describing additional contextual information of the image. Thereby, additional contextual information may comprise at least one of image quality, image mode, weather, and/or lighting in the initial textual description. Image quality may refer to at least one of sharpness, resolution, color(s), and presence/absence of artifacts. Artifacts may be any visual anomalies that degrade the image quality and do not represent the true scene. Digital image artifacts may comprise compression artifacts (e.g., blockiness, blurring), noise (e.g., graininess), aliasing (e.g., jagged edges), color banding, sensor dust (e.g., dark spots), motion blur, and distortions from lens imperfections or sensor limitations. Common image modes include RGB (Red, Green, Blue), CMYK (Cyan, Magenta, Yellow, Black), grayscale, and indexed color. The image mode defines the way color data of an image is represented and stored.

Advantageously, and particularly by the above-described request for describing additional contextual information, the method proposed herein allows for capturing broader contextual details such as weather, lighting, and image mode, which may be beneficial, may be crucial, for an image and scene analysis and deep image and scene understanding. Particularly, by capturing additional contextual information such as image quality, image mode, weather, and/or lighting in the initial textual description, an even richer and even more accurate scene graph may be obtained for a more detailed understanding of the image.

Preferably, the number N of iterations is reached when for each source node and for each target node in the updated set of triplets at least one attribute is determined in the data base. Alternatively, the number N of iterations may be reached, when for each source node and each target node in the updated set of triplets a pre-defined number of attributes is determined in the data base. E.g., a pre-defined number of attributes may be two attributes per node. Alternatively, the number N of iterations may be reached when for a predefined number of source nodes and a predefined number of target nodes at least one attribute is determined from the data base. The latter case allows to determine attributes only for selected nodes. According to yet another alternative, the number of iterations N may be fixed/pre-defined and may in particular be chosen independently of the number of source nodes and target nodes in the (updated) set of triplets. Choosing the one or other of the aforementioned options may control the degree of accuracy and/or the level of detail of the finally determined scene graph.

Advantageously, in all aforementioned cases, the number N allows to determine the level of detail and/or accuracy required/desired for the image description with the scene graph.

Preferably, in each iteration, the question is determined from a predefined template. The template comprises at least one placeholder for a source or a target node and at least one placeholder for an attribute. The placeholder for the source or target node is replaced by the selected source or target node and the placeholder for the attribute is replaced by the corresponding determined attribute. For instance, a template may be given by “Describe the [attribute] of the [node]”, wherein [attribute] represents, in this particular example, the placeholder for the attribute, and [node] represents the placeholder for the source or target node.

Advantageously, the use of a template for question determination enables systematic exploration of potential attributes of objects in the image by providing a structured querying approach. The generated targeted questions, which are further based on relations from the data base, elicit relevant and meaningful information from the machine learning system eventually leading to a richer and more informative scene graph.

Preferably, the input image is acquired with an image sensor of a camera or video camera. Accordingly, the input image comprises a plurality of pixels arranged in at least two dimensions, each pixel having at least one associated pixel attribute, wherein a pixel attribute is selected from the group comprising at least color, depth, and intensity. Accordingly, the machine learning system uses the pixel attributes when determining from the input image and a initial/determined natural language question, an initial/current textual description of the image.

Preferably, the data base is a commonsense knowledge graph. Exemplarily, the data base may be given by ConceptNet, https://arxiv.org/abs/1612.03975, a knowledge graph that connects words and phrases of natural language with labeled edges. An advantage of using a commonsense knowledge graph, such as ConceptNet, as the data base is its rich collection of commonsense relationships between concepts, allowing for broader and more nuanced exploration of potential image attributes beyond simple object labels. This may lead to more comprehensive, more accurate and richer scene graphs.

While a commonsense knowledge graph like ConceptNet offers broad coverage, the data base may, alternatively, be a domain-specific knowledge graph. In situations where the target image or information pertains to a specialized field, such as medical imaging or manufacturing processes, a domain-specific knowledge graph can provide more relevant and precise contextual information. This specialized knowledge graph may contain terminology and relationships tailored to the specific domain, enabling more accurate and targeted information extraction compared to a general commonsense knowledge graph.

Preferably, the input image depicts an environment of an at least partly autonomous robot. The method then comprises the further steps of determining a control signal for the robot based on the generated scene graph and controlling the robot in the environment by the control signal. By generating a control signal directly from the enriched scene graph, the robot can make more informed and nuanced decisions about its actions within its environment.

According to a further aspect, the disclosure relates to a data processing system comprising a processor configured to perform a method as described herein.

According to a further aspect, the disclosure relates to a computer program comprising machine-readable instructions, which, when the program is executed by a computer, cause the computer to carry out one of the computer-implemented methods described above and below. Furthermore, according to another aspect, the disclosure relates to a machine-readable storage medium, on which the above computer program is stored.

### BRIEF DESCRIPTION OF THE DRAWINGS

Embodiments of the disclosure will be discussed with reference to the following figures in more detail. The figures show:

FIG. 1 a flow chart of an exemplary embodiment;

FIG. 2 a flow chart of an exemplary embodiment.

### DETAILED DESCRIPTION

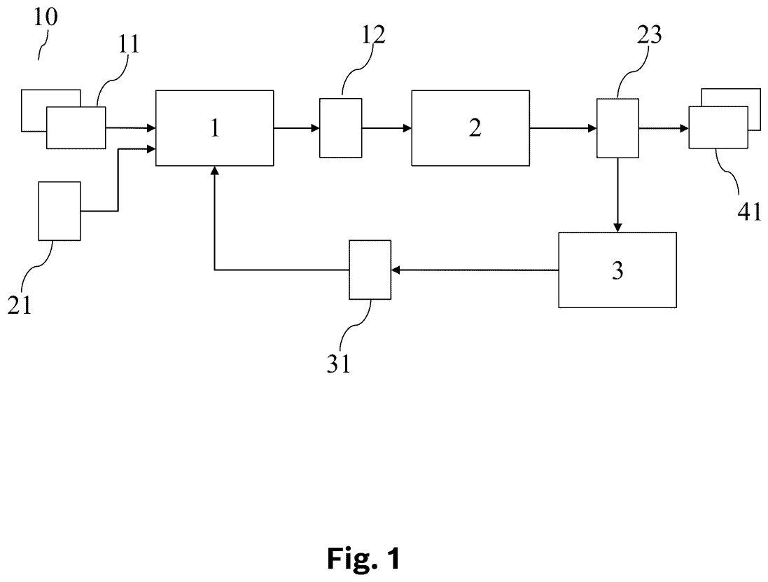

FIG. 1 shows an exemplary embodiment of a method of generating a scene graph 31 from an input image 11. A dataset 10 may be provided comprising several images. To describe each image in dataset 10, a set of adaptable questions, 21, 31, about each image is posed. A multimodal foundation model, machine learning system 1,—receiving images and text as input data and generating an output text based on the input image and text—is used to answer each of the adaptable questions. For instance, the opensource foundation model LLaVA v1.6 may be used as machine learning system 1. The questions provided to machine learning system 1 are adapted based on the content of the image. At the beginning, the machine learning system receives image 11 and initial natural language question 21. Question 21 asks the machine learning system 1 to provide as output detailed description 12 of image 11. Information extraction module 2 then extracts from natural language description 12 an initial set 23 of triplets, each triplet comprising a source node, a relation and a target node. For instance, an OpenIE module/component, e.g., Stanza's OpenIE component, may be used as information extraction module 2 to parse the (response) description 12 into triplets, wherein each triplet in set 23 consists of a source, relation, and target, respectively. Next, at least one source or target node from set 23 of triplets is selected and commonsense knowledge graph (CSKG) 3 is employed to formulate additional questions 31 about the selected source and target nodes extracted from the machine learning system's 1 response 12. For instance, ConceptNet may be chosen as commonsense knowledge graph 3. The aim of a question 31 is to extract more specific information about the source and target nodes in set 23. Questions 31 are generated by identifying a most similar (according to, e.g. cosine similarity between node embeddings) node in the CSKG 3 to a selected source/target node in set 23 and then considering the relations of the most similar node in CSKG 3 as the set of potential attributes for the respective selected source/target node. In this way, from commonsense knowledge graph 3 an attribute related to the selected source or target node is determined. Subsequently, natural language question 31 is formulated based on the determined attributes and the respective selected source or target node. To this end, a template may be used. The template may comprise at least one placeholder for the respective source/target node and at least one placeholder for a corresponding determined attribute. The placeholder for the source or target node is then replaced by the selected source or target node and the placeholder for the attribute is replaced by the corresponding determined attribute. For instance, a template may be given by “Describe the [attribute] of the [node]”, wherein [attribute] represents, in this particular example, the placeholder for the attribute, and [node] represents the placeholder for the source or target node. For instance, a node “vehicle” in the CSKG may have an attribute “type,” leading to the question “Describe the type of the vehicle.”. Generally, in the context of the disclosure, it is understood, that questions 21, 31, provided to machine learning system 1, may also comprise instructions seeking for information. Accordingly, “Describe the [attribute] of the [node]” is considered as a viable question 21, 31, as well as the reformulated version “What is the [attribute] of the [node]”. Machine learning system 1 then receives question 31 and, based on question 31 and image 11, generates a further textual description 12i of image 11. By information extraction module 2, further triplets are then extracted from the new, further description 12i and combined with the existing triplets to form an updated set 23i for the next iteration. This process may, exemplarily, repeat for each source/target node extracted for N iterations. N is a tunable parameter that determines the level of detail required for the image descriptions and may be chosen or determined according to the desired richness and accuracy of the scene graph. For instance, N may be determined such that for each source and target node out of the (repetitively updated) set 23, at least one attribute is determined. Eventually, scene graph 41 is built from the combined/repetitively updated sets 23 of triplets after N iterations.

Consequently, each triplet extracted from machine learning system's 1 answers—e.g. from LLaVA's answers—contributes an edge in scene graph 41 representing the image's 11 content. Accordingly, the triplet extraction abstracts the textual descriptions into graphs.

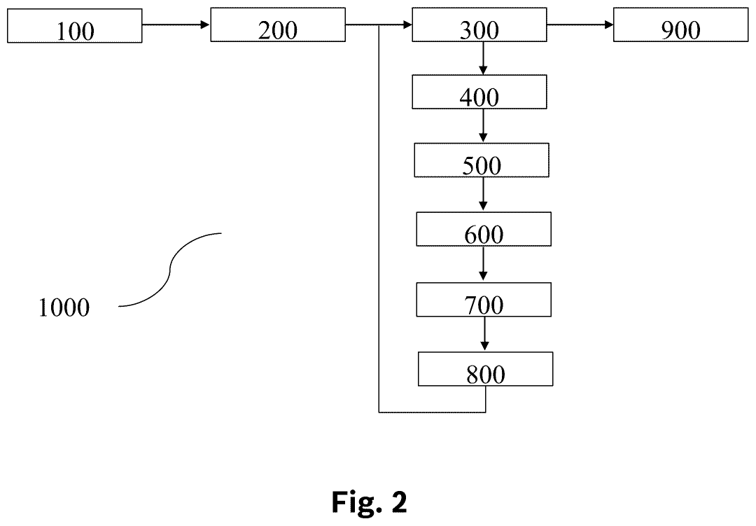

FIG. 2 shows a flow chart of an exemplary embodiment of the method of generating a scene graph from an input image. In method step 100, an initial an initial textual description of the image is generated from the input image and an initial natural language question, using a machine learning system, such as, e.g. LLaVA. In step 200, an information extraction module extracts from the initial textual description an initial set of triplets, each triplet comprising a source node, a relation and a target node. This set of triplets is then iteratively expanded by N repetitions of the following steps (steps 300 to 800): selecting, in step 300 a node from the current set of triplets; determining (step 400) a related attribute from a database; generating (step 500) a question based on the node and attribute; using the question to obtain (step 600) a further textual description from the machine learning system; extracting (step 700) further triplets from the new description; and combining (step 800) the current and further triplets to form an updated set for the next iteration. Finally, in step 900, the scene graph is constructed from the combined sets of triplets after N iterations. cm What is claimed is:

1. A computer-implemented method of generating a scene graph from an input image, the method comprising:
generating, by a machine learning system, from the input image and an initial natural language question, an initial textual description of the image;
extracting, by an information extraction module, from the initial textual description an initial set of triplets, each triplet comprising a source node, a relation and a target node;
for a number N of iterations, where N>1:
selecting at least one source or target node from a current set of triplets, wherein the initial set of triplets forms the current set of triplets for a first iteration;
determining from a data base an attribute related to the at least one selected source or target node;
determining a question based on the selected source or target node and the corresponding determined attribute;
determining, by the machine learning system, from the image and the determined question, a further textual description of the image,
extracting, by the information extraction module, a further set of triplets from the further textual description; and
combining the current set of triplets and the further set of triplets to an updated set of triplets, the updated set forming the current set for a next iteration; and
constructing the scene graph from the combined sets of triplets after N iterations.

2. The method according to claim 1, wherein the scene graph comprises nodes representing the sources and targets of the combined sets of triplets and comprises edges between nodes representing the relations connecting the sources and targets.

3. The method according to claim 1, wherein the initial natural language question comprises a request for describing additional contextual information of the image comprising at least one of image quality, image mode, weather, and/or lighting in the initial textual description.

4. The method according to claim 1, wherein the number N of iterations is reached when for each source node and for each target node in the updated set of triplets at least one attribute is determined in the data base.

5. The method according to claim 1, wherein in each iteration the question is determined from a predefined template, wherein the template comprises at least one placeholder for a source or a target node and at least one placeholder for an attribute, and wherein the placeholder for the source or target node is replaced by the selected source or target node and the placeholder for the attribute is replaced by the corresponding determined attribute.

6. The method according to claim 1, wherein the input image is acquired with an image sensor of a camera or video camera, and wherein the input image comprises a plurality of pixels arranged in at least two dimensions, each pixel having at least one associated pixel attribute.

7. The method according to claim 1, wherein the data base is a commonsense knowledge graph or a domain-specific knowledge graph.

8. The method according to claim 1, wherein the input image depicts an environment of an at least partly autonomous robot, the method further comprising:
determining a control signal for the robot based on the generated scene graph and controlling the robot in the environment by the control signal.

9. A data processing system, comprising a processor configured to perform the method according to claim 1.

10. A computer program comprising instructions which, when the program is executed by a computer, cause the computer to carry out the method according to claim 1.

11. A computer-readable data carrier having stored thereon the computer program of claim 10.
